(19) United States
(12) Patent Application Publication
(10) Pub. No.: US 2019/0050003 A1
(43) Pub. Date: Feb. 14, 2019

(54) SYSTEMS AND METHODS TO DYNAMICALLY CONFIGURE DATA VALUES STORED ON A MASS FLOW CONTROLLER

(71) Applicant: Illinois Tool Works Inc., Glenview, IL (US)

(72) Inventors: Berwin BANARES, Glenview, IL (US); Chris ELLEC, Glenview, IL (US)

(21) Appl. No.: 16/071,719

(22) PCT Filed: Jan. 20, 2017
(86) PCT No.: PCT/US2017/014258

§ 371 Date: Jul. 20, 2018

Related U.S. Application Data
(60) Provisional application No. 62/286,214, filed on Jan. 22, 2016.

(51) Int. Cl. G05D 7/06; G05B 17/02

(52) U.S. Cl. CPC G05D 7/0635; G01F 1/69; G05B 17/02

(57) ABSTRACT

The disclosed embodiments include systems and methods to dynamically configure data values stored on a mass flow controller (MFC). In one embodiment, the MFC includes an inlet for receiving fluid, a flow path, a mass flow sensor for providing a signal corresponding to mass flow of the fluid through the flow path, and a valve for regulating a flow of the fluid out of an outlet of the MFC. The MFC also includes a storage medium having a fluid model of the fluid and a file system for configuring the fluid model. The MFC further includes a processor operable to perform operations including receiving instructions to configure the fluid model, obtaining MFC data indicative of a change to the fluid model, and utilizing the file system to dynamically update the fluid model with MFC data indicative of the change in the fluid model.

### BACKGROUND

The present disclosure relates generally to systems and methods to dynamically configure data values stored on a mass flow controller.

A mass flow controller is a device used to measure and control the flow of liquids and gases. A mass flow controller is designed and calibrated to control a specific type of liquid or gas at a particular range of flow rates. The mass flow controller can be given a setpoint from 0 to 100% of its full scale range but is typically operated in the 10 to 90% of full scale where the best accuracy is achieved. The device will then control the rate of flow to the given setpoint. Mass flow controllers can be either analog or digital. A digital flow controller is usually able to control more than one type of fluid whereas an analog controller is limited to the fluid for which it was calibrated.

Many mass flow controllers have an inlet port, an outlet port, a mass flow sensor and a proportional control valve. The mass flow controller is fitted with a closed loop control system which is given an input signal by the operator (or an external circuit/computer) that it compares to the value from the mass flow sensor and adjusts the proportional valve accordingly to achieve the required flow. The flow rate is specified as a percentage of its calibrated full scale flow and is supplied to the mass flow controller as a voltage signal.

### BRIEF SUMMARY OF THE DISCLOSED EMBODIMENTS

The disclosed embodiments provide systems and methods to dynamically configure data values stored on a mass flow controller. In accordance with one illustrative embodiment, a mass flow controller is provided. The mass flow controller includes an inlet for receiving fluid. The mass flow controller also includes a flow path in which the fluid passes through the mass flow controller. The mass flow controller further includes a mass flow sensor for providing a signal corresponding to mass flow of the fluid through the flow path. The mass flow controller further includes a valve for regulating a flow of the fluid out of an outlet of the mass flow controller. The mass flow controller further includes a storage medium having a fluid model of the fluid; and a file system for configuring the fluid model. The mass flow controller further includes a processor operable to execute instructions to perform operations includes receiving instructions to configure the fluid model, obtaining mass flow controller data indicative of a change to the fluid model; and utilizing the file system to dynamically update the fluid model with mass flow controller data indicative of the change in the fluid model.

In accordance with another illustrative embodiment, a computer implemented method to dynamically reconfigure data values stored on a mass flow controller is provided. The method includes receiving instructions to configure mass flow controller data. The method also includes determining a location on a storage medium component of the mass flow controller for storing the mass flow controller data, the storage medium having a first partition, wherein the location corresponds to a location of the first partition of the storage medium designated to store the mass flow controller data. The method further includes dynamically adjusting a partition size of the partition of the storage medium designated to store the mass flow controller data if a size of the mass flow controller data is greater than an amount of available storage space of the partition of the storage medium designated to store the mass flow controller data. The method further includes storing the mass flow controller data at the location on the storage medium.

In accordance with a further illustrative embodiment, a non-transitory computer-readable medium comprising instructions stored therein, which when executed by one or more processors, causes the one or more processors to perform operations to dynamically configure data values stored on a mass flow controller is provided. The instructions include instructions to receive instructions to store mass flow controller data on a storage medium of a mass flow controller. The instructions also include instructions to utilize a file system to determine if a data file designated to hold the mass flow controller data is stored on the storage medium. The instructions also include instructions to update the data file to include the mass flow controller data if the data file is stored on the storage medium. The instructions further include instructions to create a new data file having the mass flow controller data if the data file is not stored on the storage medium.

Additional details of the disclosed embodiments are provided below in the detailed description and corresponding drawings.

### BRIEF DESCRIPTION OF THE DRAWINGS

Illustrative embodiments of the present invention are described in detail below with reference to the attached drawing Figures, which are incorporated by reference herein, and wherein:

FIG. 1 is a schematic view of a mass flow controller in accordance with a disclosed embodiment.

FIG. 2 is a schematic view of a memory structure of a storage medium of a mass flow controller of FIG. 1 having a partition for storing mass flow controller data in accordance with a disclosed embodiment.

FIG. 3 is a schematic view of a memory structure of a mass flow controller of FIG. 1 having multiple partitions for storing different types of mass flow controller data in accordance with a disclosed embodiment.

FIG. 4 is a schematic view of a memory structure of a storage medium of a mass flow controller of FIG. 1 having a partition for storing gas models in accordance with a disclosed embodiment.

FIG. 5 is a schematic view of a memory structure of a mass flow controller of FIG. 1 having multiple partitions for storing different gas models in accordance with a disclosed embodiment.

The illustrated figures are only exemplary and are not intended to assert or imply any limitation with regard to the environment, architecture, design, or process in which different embodiments may be implemented.

### DETAILED DESCRIPTION

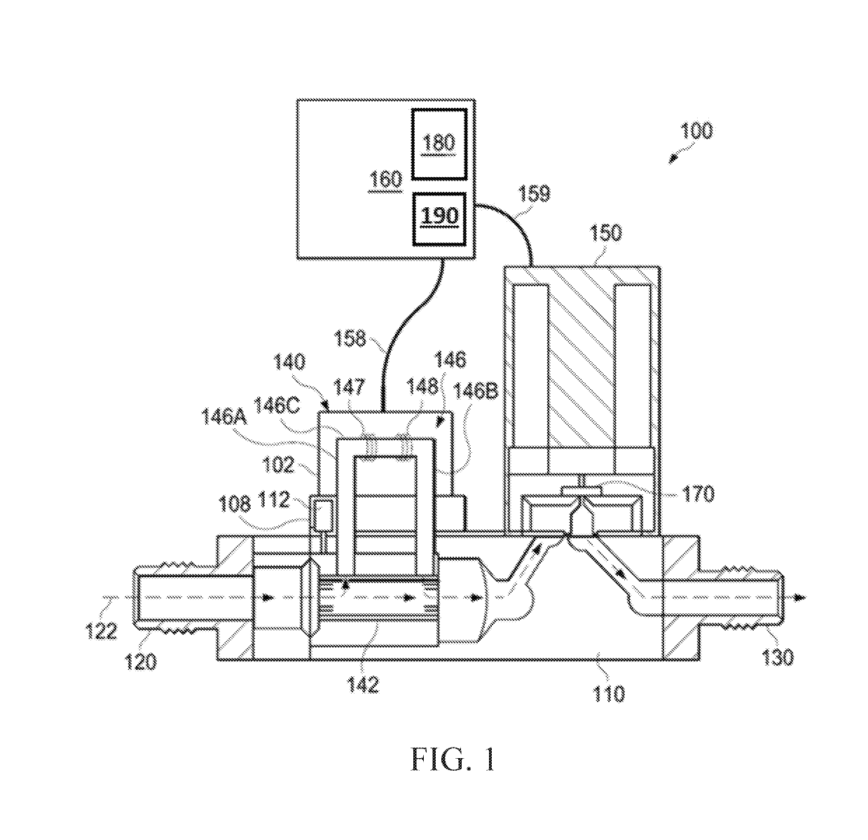

FIG. 1 illustrates an example of a mass flow controller 100 in accordance with a disclosed embodiment. The mass flow controller 100 includes a block 110, which is the platform on which the components of the mass flow controller are mounted. A thermal mass flow meter 140 and a valve assembly 150 containing a valve 170 are mounted on the block 110 between a fluid inlet 120 and a fluid outlet 130. In the embodiment of FIG. 1, fluidly substances flow into the fluid inlet 120 in a direction indicated by arrow 122, through the mass flow controller 100 and exit the fluid outlet 130. As defined herein, fluidly substances include various fluids, gases, and vapors that flow through the fluid inlet 120 and the fluid outlet 130 of the mass flow controller 100. Although the below paragraphs primarily discuss performing operations on fluids that flow through the controller 100, one of ordinary skill would understand that operations performed by the mass flow controller 100 may be performed with respect to different types of fluidly substances that flow through the mass flow controller 100.

The thermal mass flow meter 140 includes a bypass 142 through which typically a majority of fluid flows and a thermal flow sensor 146 through which a smaller portion of the fluid flows. The bypass 142 is tuned with the known fluid to determine an appropriate relationship between fluid flowing in the mass flow sensor and the fluid flowing in the bypass 142 at various known flow rates, so that the total flow through the flow meter can be determined from the sensor output signal. The mass flow sensor portion and bypass 142 may then be mated to the control valve 170 and control electronics 160 and then tuned again, under known conditions. The responses of the control electronics 160 and the control valve 170 are then characterized so that the overall response of the system to a change in set point or input pressure is known, and the response can be used to control the system to provide the desired response.

Thermal flow sensor 146 is contained within a sensor housing 102 (portion shown removed to show sensor 146) mounted on a mounting plate or base 108. The thermal flow sensor 146 is a tube, typically referred to as a capillary tube, with a sensor inlet portion 146A, a sensor outlet portion 146B, and a sensor measuring portion 146C about which two resistive coils or windings 147, 148 are disposed. In operation, electrical current is provided to the two resistive windings 147, 148, which are in thermal contact with the sensor measuring portion 146C. The current in the resistive windings 147, 148 heats the fluid flowing in measuring portion 146 to a temperature above that of the fluid flowing through the bypass 142. The resistance of windings 147, 148 varies with temperature. As fluid flows through the sensor conduit, heat is carried from the upstream resistor 147 toward the downstream resistor 148, with the temperature difference being proportional to the mass flow rate through the thermal flow sensor 146.

An electrical signal related to the fluid flow through the thermal flow sensor 146 is derived from the two resistive windings 147,148. The electrical signal may be derived in a number of different ways, such as from the difference in the resistance of the resistive windings or from a difference in the amount of energy provided to each resistive winding to maintain each winding at a particular temperature. Examples of various ways in which an electrical signal correlating to the flow rate of a fluid in a thermal mass flow meter may be determined are described, for example, in commonly owned U.S. Pat. No. 6,845,659, which is hereby incorporated by reference. The electrical signals derived from the resistive windings 147, 148 after signal processing comprise a sensor output signal.

The sensor output signal is correlated to mass flow in the mass flow meter so that the fluid flow can be determined when the electrical signal is measured. The sensor output signal is typically first correlated to the flow in the thermal flow sensor 146, which is then correlated to the mass flow in the bypass 142, so that the total flow through the flow meter can be determined and the control valve 170 can be controlled accordingly. The correlation between the sensor output signal and the fluid flow is complex and depends on a number of operating conditions including fluid species, flow rate, inlet and/or outlet pressure, temperature, etc.

The process of correlating raw sensor output to fluid flow entails tuning and/or calibrating the mass flow controller and is an expensive, labor intensive procedure, often requiring one or more skilled operators and specialized equipment. For example, the mass flow sensor may be tuned by running known amounts of a known fluid through the sensor portion and adjusting certain signal processing parameters to provide a response that accurately represents fluid flow. For example, the output may be normalized, so that a specified voltage range, such as 0 V to 5 V of the sensor output, corresponds to a flow rate range from zero to the top of the range for the sensor. The output may also be linearized, so that a change in the sensor output corresponds linearly to a change in flow rate. For example, doubling of the fluid output will cause a doubling of the electrical output if the output is linearized. The dynamic response of the sensor is determined, that is, inaccurate effects of change in pressure or flow rate that occur when the flow or pressure changes are determined so that such effects can be compensated.

When the type of fluid used by an end-user differs from that used in tuning and/or calibration, or when the operating conditions, such as inlet and outlet pressure, temperature, range of flow rates, etc., used by the end-user differ from that used in tuning and/or calibration, the operation of the mass flow controller is generally degraded. For this reason, the flow meter can be tuned or calibrated using additional fluids (termed “surrogate fluids”) and or operating conditions, with any changes necessary to provide a satisfactory response being stored in a lookup table. U.S. Pat. No. 7,272,512 to Wang et al., for “Flow Sensor Signal Conversion,” which is owned by the assignee of the present invention and which is hereby incorporated by reference, describes a system in which the characteristics of different gases are used to adjust the response, rather than requiring a surrogate fluid to calibrate the device for each different process fluid used.

In some embodiments, the mass flow controller 100 includes additional sensors (not shown) operable to determine the flow rate and properties of fluids flowing through the mass flow controller 100. In one of such embodiments, the fluid mass flow controller 100 includes a temperature sensor operable to determine the temperature of fluids flowing through the mass flow controller 100. In another one of such embodiments, the fluid mass flow controller 100 includes an accelerometer operable to determine an acceleration of fluids flowing through the mass flow controller 100 as well as a change in the flow rate of fluids flowing through the mass flow controller 100.

In addition, the mass flow controller 100 may include a pressure transducer 112 coupled to flow path at some point, typically, but not limited to, upstream of the bypass 142 to measure pressure in the flow path. Pressure transducer 112 provides a pressure signal indicative of the pressure. In accordance with the disclosed embodiments, the pressure transducer 112 is used to measure pressure during a rate of decay measurement.

Control electronics 160 control the position of the control valve 170 in accordance with a set point indicating the desired mass flow rate, and an electrical flow signal from the mass flow sensor indicative of the actual mass flow rate of the fluid flowing in the sensor conduit. Traditional feedback control methods such as proportional control, integral control, proportional-integral (PI) control, derivative control, proportional-derivative (PD) control, integral-derivative (ID) control, and proportional-integral-derivative (PID) control are then used to control the flow of fluid in the mass flow controller. A control signal (e.g., a control valve drive signal) is generated based upon an error signal that is the difference between a set point signal indicative of the desired mass flow rate of the fluid and a feedback signal that is related to the actual mass flow rate sensed by the mass flow sensor. The control valve is positioned in the main fluid flow path (typically downstream of the bypass and mass flow sensor) and can be controlled (e.g., opened or closed) to vary the mass flow rate of fluid flowing through the main fluid flow path, the control being provided by the mass flow controller.

In the illustrated example, the flow rate is supplied by electrical conductors 158 and 159 to a closed loop system controller as a voltage signal. The signal is amplified, processed and supplied to the control valve assembly 150 to modify the flow. To this end, the controller 160 compares the signal from the mass flow sensor 140 to predetermined values and adjusts the proportional valve 170 accordingly to achieve the desired flow.

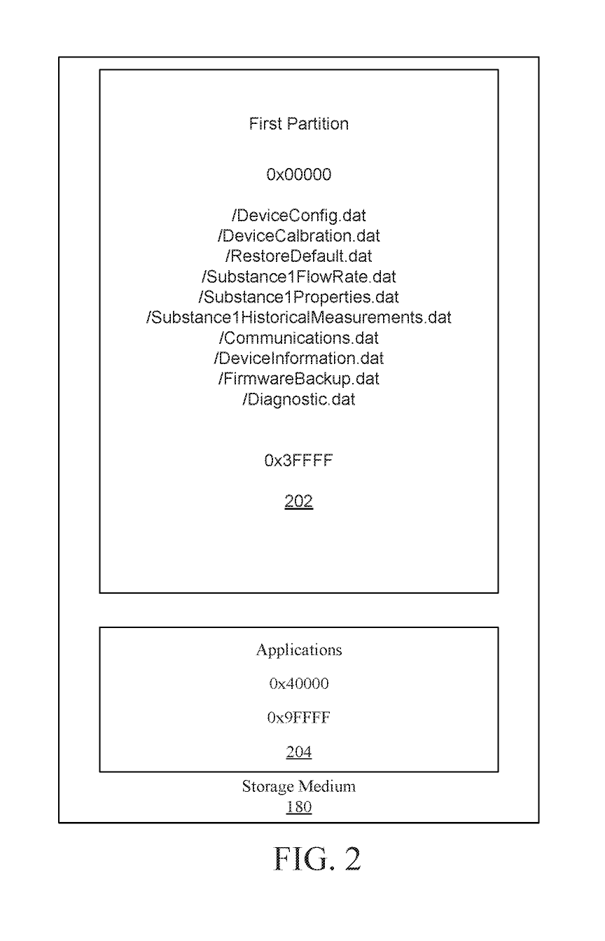

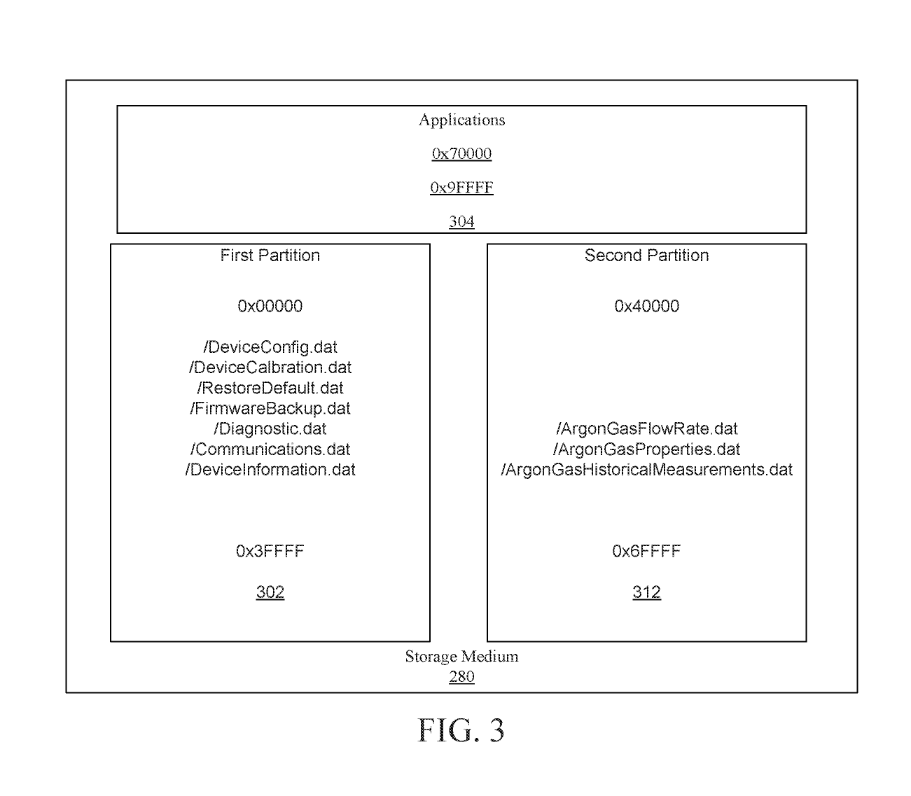

Data indicative of measurements of substances flowing through the mass flow controller 100 (mass flow controller measurement data) and data indicative of default, historical, and/or present device attributes of the mass flow controller 100 (mass flow controller settings data, the mass flow controller settings data and the mass flow controller measurement data collectively referred to as mass flow controller data) are stored on storage medium 180. Additional examples of mass flow controller measurement data and mass flow controller measurement data are provided in the paragraphs below and are illustrated in at least FIGS. 2 and 3. The storage medium 180 may be formed from data storage components such as, but not limited to, read-only memory (ROM), random access memory (RAM), flash memory, magnetic hard drives, solid state hard drives, CD-ROM drives, DVD drives, floppy disk drives, as well as other types of data storage components and devices. In some embodiments, the storage medium 180 includes multiple data storage devices.

The storage medium 180 also includes at least one partition for storing the mass flow controller data. As defined herein, a partition may be a physical partition of the storage medium 180 or a logical partition of the storage medium 180. Each partition of the at least one partition has a default storage space, some of which, may be reallocated to another partition of the at least one partition. Each partition has a variable size ranging from one bit to a size approximately equal to the total storage space of the storage medium 180. For example, the storage medium 180 includes a first partition designated to store mass flow controller settings data and a second partition designated to store mass flow controller measurement data. In one embodiment, when the amount of available storage space of the first partition dips below a first threshold storage size, and the amount of available storage space of the second partition is above the first threshold storage size, then an amount of available storage space of the second partition is reallocated to the first partition, thereby increasing the amount of free storage space of the first partition of the storage medium 180. The first size threshold may be the size of mass flow controller data to be stored on the first partition or another measurement of the storage space.

The storage medium 180 also includes different fluid models of different fluids that flow through the mass flow controller 100. The fluid models may be periodically updated to accurately represent the fluids flowing through the mass flow controller 100. Moreover, the mass flow controller 100 may periodically receive mass flow data indicative of a change to one or more existing fluid models stored on the storage medium 180.

In some embodiments, applications that are operable to perform operations described herein to dynamically configure/reconfigure data values stored on a mass flow controller are stored on the storage medium 180. In one of such embodiments, the foregoing applications include a file system application having access to existing gas models and gas database that are stored on the storage medium 180. The file system is operable to update fluid models stored on the storage medium with mass flow controller data indicative of changes to the fluid models. In another one of such embodiments, the file system is operable to create a new fluid model and to store mass flow controller data indicative of the new fluid model on the storage medium 180. The file system is operable to make dynamic changes to existing fluid models, dynamically create new fluid models, and dynamically configure other settings of the mass flow controller 100 to configure/reconfigure gas on the fly with just a single command from the mass flow controller 100, instead of having separate software (running on an external machine) run the configuration, which would require the mass flow controller 100 to be shut down while separate software are run to update the gas models stored on the storage medium 180. To the contrary, the file system allows updates to be gas model as well as other data stored on the mass flow controller 100 to be dynamically configured and/or reconfigured while the mass flow controller 100 is in operation. In another one of such embodiments, the file system is also operable to filter the storage medium 180 to determine the location of mass flow controller data stored on the storage medium 180. In such embodiment, the file system application is utilized to control how data, such as mass flow controller data is stored and retrieved. Various types of file system applications may be used in accordance with the mass flow controller 100, such as but not limited to, File Allocation Table (FAT) including FAT12, FAT16, FAT32, Extended File Allocation Table (exFAT), New Technology File System (NTFS), Yet Another Flash File System2 (YAFFS2), Transparent File System (TFS), as well as other types of file system applications operable to determine the location of mass flow controller data stored on the storage medium 180. The file system application provides flexibility in the mass flow controller 100 when future upgrades and improvements to device functionalities are required. For example, when flash density changes, data management will be properly handled with the file system application in place. This provides the mass flow controller storage to be independent of what the actual hardware is used (e.g. Flash chip, SD card, etc.). In one embodiment, the file system driver is included in the firmware. Moreover, the file system application is compatible with advanced protocols such as file transfer support and Universal Serial Bus (USB), thereby facilitating faster download of mass flow controller data stored on the storage medium 180 and faster write time of mass flow controller data to the storage medium 180. In one embodiment, the file system application reduces changes to the firmware of the mass flow controller when storage density or when updates in functionality that requires non-volatile data storage changes.

In further embodiments, instructions for performing the operations described herein to dynamically configure mass flow controller data are also stored on the storage medium 180. In one of such embodiments, instructions to store and/or configure mass flow controller data on the storage medium 180, instructions to determine if a data file designated to hold the mass flow controller data is stored on the storage medium 180, instructions to update the data file to include the mass flow controller data if the data file is stored on the storage medium, instructions to create a new data file having the mass flow controller data if the data file is not stored on the storage medium 180, as well as other instructions described herein or performed in the operations described herein are stored on the storage medium 180. As defined herein, a data file is any electronic file designated to hold mass flow controller data described herein. Although FIG. 1 illustrates the storage medium 180 as a component of the control electronics 160, the storage medium 180 may be standalone component of the mass flow controller 100. Further, in some embodiments, the storage medium 180 is a removable component that may be readily removed from the mass flow controller 100. In one of such embodiments, the removed mass flow controller may be plugged into a remote electronic device to facilitate data extraction of mass flow controller data stored on the storage medium 180. Additional descriptions regarding data stored on the storage medium 180 are provided in the paragraphs below and are illustrated in at least FIGS. 2 and 3.

The mass flow controller 100 also includes a processor 190 operable to perform the operations described herein to dynamically configure/reconfigure data values stored on the mass flow controller and to write new data onto the storage medium 180. In some embodiments, the processor 190 is operable to execute instructions stored in the storage medium 180 to receive instructions to configure the fluid model, obtain mass flow controller data indicative of a change to the fluid model, and utilize the file system to dynamically update the fluid model with mass flow controller data indicative of the change in the fluid model. In one of such embodiments, the processor 190 is further operable to determine whether data received by the mass flow controller 100 is associated with any existing gas model and to create new fluid models and to store the new fluid models on the storage medium 180 if the data received by the mass flow controller 100 is not associated with any existing gas model that is stored on the storage medium 180

In further embodiments, the processor 190 is also operable to execute the instructions stored in the storage medium 180 to retrieve instructions to configure mass flow controller data, utilize the file system application to determine a location on the storage medium 180 for storing the mass flow controller data, the location corresponding to a partition of the storage medium 180 designated to store the mass flow controller data, dynamically adjust a partition size of at least one partition of the plurality of partitions if a size of the mass flow controller data is greater than an amount of available storage space of the partition of the storage medium 180 designated to store the mass flow controller data, store the mass flow controller data at the location on the storage medium 180, as well as other operations described herein. Although FIG. 1 illustrates the processor 190 as a component of the control electronics 160, the processor 190 may be standalone component of the mass flow controller 100. Additional descriptions regarding the operations of the processor 190 are provided in the paragraphs below and are illustrated in at least FIGS. 2 and 3.

FIG. 2 is a schematic view of a memory structure of the storage medium 180 of the mass flow controller 100 of FIG. 1 having a partition 202 for storing mass flow controller data in accordance with a disclosed embodiment. As defined herein, mass flow controller data include mass flow controller settings data and mass flow controller measurement data. In some embodiments, mass flow controller settings data include data indicative of a current configuration of the mass flow controller 100, a current calibration of the mass flow controller 100, a current communications configuration of the mass flow controller 100, current mass flow controller 100 information, scratch pad of the mass flow controller 100, firmware backup information of the mass flow controller 100, a restore point of the mass flow controller, diagnostic data of the mass flow controller 100, as well as other data indicative of various settings of the mass flow controller. In further embodiments, mass flow controller measurement data include data indicative of a flow rate of a fluid, a gas, or a vapor that flows through the mass flow controller 100, a change in the flow rate of the fluid, gas, or vapor, historical measurements of the flow rate of the fluid, gas, or vapor, as well as other values indicative of measurements obtained by the mass flow controller 100.

In some embodiments, mass flow controller data are stored on different data files. For example, data indicative of the current device configuration of the mass flow controller 100 are stored on a first data file, data indicative of the current device calibration of the mass flow controller 100 are stored on a second data file, and data indicative of the default device configuration of the mass flow controller 100 are stored on a third data file. Moreover, data indicative of a flow rate of a substance, such as a fluid, gas, or vapor that flows through the mass flow controller 100 are stored on a fourth data file, data indicative of fluidly properties of the substance are stored on a fifth data file, and data indicative of historical measurements of the substance are stored on the sixth data file. Additional data files designated to store data indicative of communication channels of the mass flow controller 100, data indicative of device information of the mass flow controller 100, data indicative of firmware backup information of the mass flow controller 100, and diagnostic data of the mass flow controller 100 are also stored on the first partition 202. Further, additional data files designated to hold additional types of mass flow controller data may also be stored on the first partition 202.

In such embodiment, different mass flow controller data may be accessed by determining the data file the mass flow controller data is stored on. Moreover, when the mass flow controller 100 receives instructions to configure/reconfigure certain mass flow controller data, the processor 190 is operable to utilize an application stored in the applications section 204 of the storage medium 180, such as a file system application, to determine which data file is designated to hold the foregoing mass flow controller data, and revise the designated data file with the foregoing mass flow controller data file. For example, if the processor 190 receives data indicative of a new device configuration, then the processor 190 is operable to utilize the file system application to determine a location of the first data file, which contains data indicative of the current device configuration of the mass flow controller 100 and to over-write pre-existing data indicative of pre-existing device configuration with the received data indicative of the new device configuration. Moreover, if the processor 190 receives instructions to restore the device configuration of the mass flow controller 100 to the default device configuration of the mass flow controller 100, then the processor 190 is operable to access the third data file to obtain data indicative of the default device configuration of the mass flow controller 100, and to over-write data indicative of the pre-existing device configuration of the mass flow controller 100, which are stored in the first data file, with data indicative of the default device configuration of the mass flow controller 100.

In some embodiments, certain mass flow controller data are not stored in the storage medium 180. For example, when a new gas, such as nitrogen gas first passes through the mass flow controller 100, the sensors of the mass flow controller, such as the thermal flow sensor 146, are operable to measure the flow rate of the nitrogen gas, the chemical properties of the nitrogen gas, as well as other measurable properties of the nitrogen gas. The processor 190 then operates the file systems application to determine whether a data file for storing data indicative of the flow rate of the nitrogen gas, the chemical properties of the nitrogen gas, as well as the other measured properties of the nitrogen has been created. The processor 190 is further operable to create a new data file for storing data indicative of the foregoing measured properties of the nitrogen gas on the newly created data file if no such data file is stored on the first partition 202. As such, the foregoing operations provide the mass flow controller 100 with dynamic access to the mass flow controller data stored on the storage medium 180, thereby allowing dynamic configuration and reconfiguration of the mass flow controller data with just a single command from the tool, instead of having separate software (running on an external machine) run the configuration/reconfiguration, thus reducing tool downtime and increasing tool throughput.

In some embodiments, the processor 190 is also operable to dynamically change the file size of one or more data files stored on the first partition 202. Continuing with the previous example, as nitrogen gas continuously flows through the mass flow controller, the processor 190 continuously receives data indicative of up-to-date measurements of the nitrogen gas as measured by the sensors of the mass flow controller 100. The processor 190 stores data of the nitrogen gas in the sixth data file, which is designated to store historical measurements of nitrogen gas. The sixth data file would continue to grow in size as the processor 190 stores additional data indicative of the measurements of the nitrogen gas on the sixth data file. In one of such embodiments, the processor 190 is operable to determine the available storage space of the first partition 202 and is operable to dynamically allocate some of the available storage space of the first partition 202 to the sixth data file. In some embodiments, the processor 190 is operable to determine the partition size of the first partition 202, the amount of available storage space of the storage medium 180, and allocate some of the available storage space of the storage medium 180 to the first partition 202. In one of such embodiments, the processor 190 determines the amount of storage space assigned to the first partition 202 and assigned to other data stored on the storage medium 180. In the example of FIG. 2, the first partition is assigned locations 0x00000 to 0x3FFFF of the storage medium 180 and the applications section 204 is assigned locations 0x40000 to 0x9FFFF of the storage medium 180. The processor 190 is then operable to determine whether some of the available storage space currently assigned to the applications section 204 may be reallocated to the first partition 202. For example, if only locations 0x80000 to 0x9FFFF are utilized, then the processor 190 is operable to assign some of the available storage at locations 0x40000 to 0x7FFFF to the first partition, thereby allowing additional mass flow controller data to be stored on the first partition 202.

FIG. 3 is a schematic view of a memory structure of a storage medium 280 of the mass flow controller 100 of FIG. 1 having multiple partitions 302 and 312 for storing different types of mass flow controller data in accordance with a disclosed embodiment. As shown in FIG. 3, applications utilized by the processor 190 to perform operations described herein are stored on applications section 304 of the storage medium 280. Data files designated to store mass flow controller settings data are stored on first partition 302 of the storage medium 180. Moreover, data indicative of the current device configuration of the mass flow controller 100 are stored on a first data file of the first partition 302, data indicative of the current device calibration of the mass flow controller 100 are stored on a second data file of the first partition 302, and data indicative of the default device configuration of the mass flow controller 100 are stored on a third data file of the first partition 302. Further, data indicative of the firmware backup information of the mass flow controller 100 are stored on a fourth data file of the first partition 302 and data indicative of the diagnostic information of the mass flow controller 100 are stored on a fifth data file of the first partition 302. Additional data files designated to store data indicative of communication channels of the mass flow controller 100, data indicative of device information of the mass flow controller 100, data indicative of firmware backup information of the mass flow controller 100, and diagnostic data of the mass flow controller 100 are also stored on the first partition 202. Further, additional data files designated to hold additional types of mass flow controller data may also be stored on the first partition 202. Further, data files designated to store mass flow measurement data are stored on the second partition 312 of the multiple partitions. Moreover, data indicative of a flow rate of argon gas through the mass flow controller 100 are stored on a first data file of the second partition 312, data indicative of properties of the argon gas are stored on a second data file of the second partition 312, and data indicative of historical measurements of the argon gas are stored on a third data file of the second partition 312.

The processor 190, upon receipt of instructions to configure mass flow controller data, is operable to determine whether the mass flow controller data is stored on the first partition 302, on the second partition 312, or neither partition. For example, if the processor 190 receives instructions to update historical measurements of argon gas with up-to-date measurements of argon gas, then the processor 190 is operable to determine the location of the second partition 312, determine the location of the third data file of the second partition 312, and update the third data file of the second partition 312 with the up-to-date measurements of argon gas. In some embodiments, a file system application is stored on the applications section 304 and the processor 190 is operable to execute the file system application to perform the foregoing operations to determine where to write the up-to-date measurements of argon gas. Similarly, if the processor 190 receives data indicative of up-to-date device calibration data of the mass flow controller 100, then the processor 190 is operable to determine the location of the first partition 302, determine the location of the second data file of the first partition 302, which includes device calibration data of the mass flow controller 100, and overwrite pre-existing device calibration data with the up-to-date device calibration data of the mass flow controller 100.

In some embodiments, the processor 190 is operable to adjust the storage size of the first partition and the second partition 302 and 312 based on the available storage space of the respective partition. In one of such embodiments, if the processor 190 receives instructions to update the second data file of the second partition 312 with data indicative of up-to-date measurements of argon gas, and the processor 190 determines that the amount of available storage space of the second partition 312 is less than the size of data indicative of the up-to-date measurements of the argon gas, then the processor 190 is operable to determine whether storage space belonging to the first partition 302 may be allocated to the second partition 312. For example, if the processor 190 determines all of the data files stored on the first partition occupy locations 0x20000 to 0x3FFFF of the storage medium 280, the processor 190 is operable to allocate locations 0x00000 to 0x1FFFF to the second partition, thereby allowing the size of the second data file to dynamically expand to accommodate additional mass flow controller data stored on the second data file.

In some embodiments, the processor 190 is operable to anticipate the growth and/or contraction of a partition over an operational duration (e.g., over an hour, a day, a week, or another operational period) and dynamically adjust the size of the partition accordingly. In one of such embodiments, the processor 190 is operable to anticipate, based on historical instructions to configure mass flow controller data, the size of the mass flow controller data over a future operational duration (e.g., hour, day, week, or other operational period). For example, if the processor 190 has received hourly instructions to update the second data file of the second partition 312 with approximately 1 megabytes of data, and the processor 190 determines that the second partition has approximately 5 megabytes of available storage space, then the processor 190 may determine that the second partition 312 may run out of available storage space in approximately 5 hours. The processor 190 then determines the amount of available storage space allocated to the first partition 302 and performs operations described herein to dynamically allocate some of the available storage space of the first partition 302 to the second partition 312 in order to allow the second data file of the second partition 312 to continue to expand.

Although FIG. 3 illustrates two partitions 302 and 312, the storage medium 280 may be divided to include any other number of partitions. In one embodiment, each data file stored on the storage medium 280 is allocated an individual partition. In such embodiment, the size of each partition may expand or contract based on the amount of data stored on the corresponding data file.

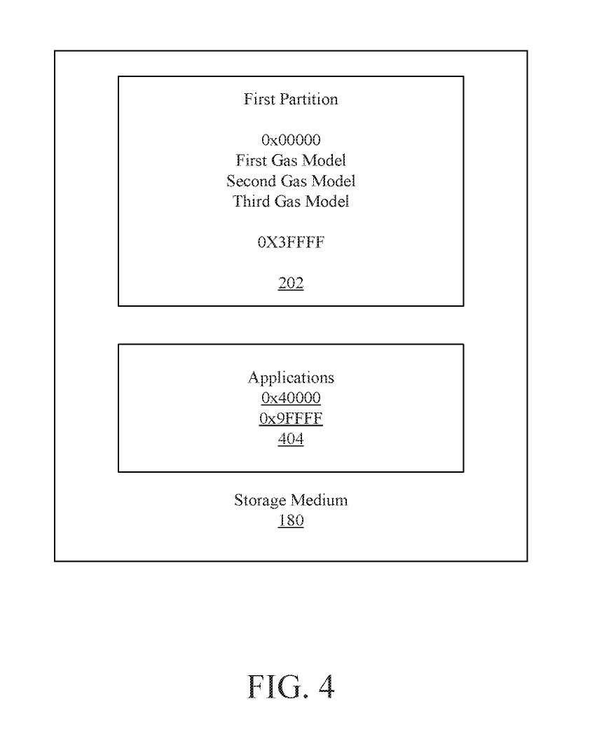

FIG. 4 is a schematic view of a memory structure of the storage medium 180 of the mass flow controller 100 of FIG. 1. The illustration of FIG. 4 is similar to the illustration of FIG. 2, such that mass flow controller data and gas models are stored on the first partition 202. In some embodiments, the mass flow controller data described herein represent data of one or more gas models illustrated in FIG. 4. For example, the mass flow controller 100 may receive mass flow controller data indicative of a change to the first fluid model. The processor 190 is operable to modify the first gas model with the received mass flow controller data. Moreover, the processor 190 is further operable to perform operations described herein to modify the storage space of the first partition 202 to ensure the first partition 202 has sufficient storage space to store all of the gas models.

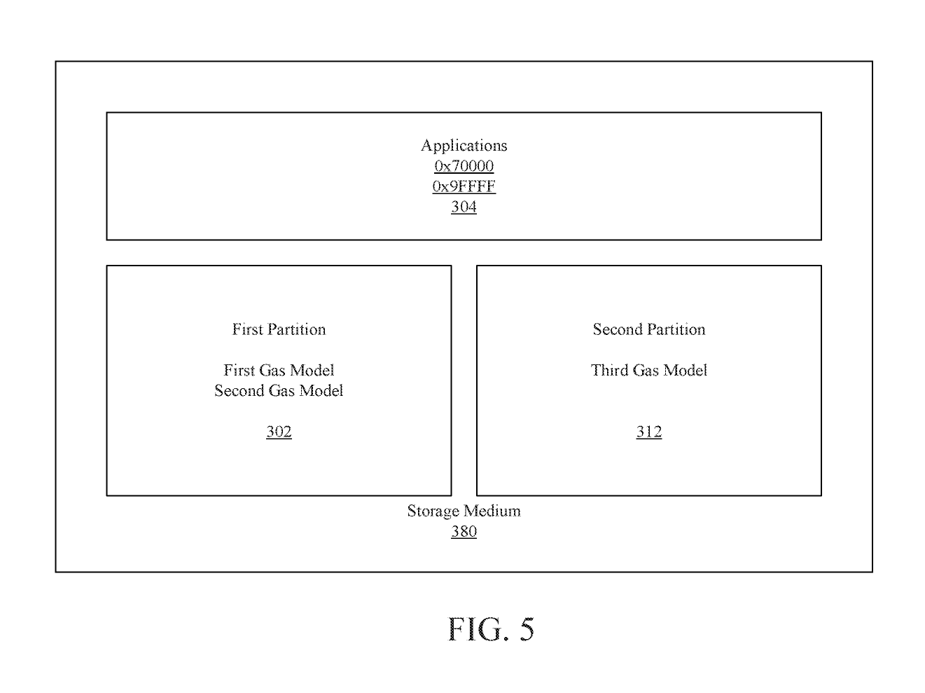

FIG. 5 is a schematic view of a memory structure of the storage medium 280 of the mass flow controller 100 of FIG. 1 having multiple partitions 302 and 312 for storing different gas models in accordance with a disclosed embodiment. In the embodiment of FIG. 5, the first gas model and the second gas model are stored on the first partition 302 whereas the third gas model is stored on the second partition 312. The available storage space of the first and the second partitions 302 and 312 dynamically vary as one or more of the first, second, and third gas models are updated. The processor 190 is operable to perform operations described herein to dynamically allocate the storage space of the first and the second partitions 302 and 312 to ensure that both partitions have sufficient storage space for the first, second, and third gas models. In some embodiments, when the processor 190 determines the available storage space of the first and the second partitions 302 and 312 prior to creating a new gas model (fourth gas model). In one of such embodiments, the processor 190 the second partition 312 contains more available storage space than the first partition 302 and subsequently stores the fourth gas model in the second partition 312.

As used in this specification and any claims of this application, the terms “computer”, “processor”, and “memory” all refer to electronic or other technological devices. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. The scope of the claims is intended to broadly cover the disclosed embodiments and any such modification.

The above disclosed embodiments have been presented for purposes of illustration and to enable one of ordinary skill in the art to practice the disclosed embodiments, but is not intended to be exhaustive or limited to the forms disclosed. Many insubstantial modifications and variations will be apparent to those of ordinary skill in the art without departing from the scope and spirit of the disclosure. The scope of the claims is intended to broadly cover the disclosed embodiments and any such modification.

As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, steps, operations, elements, and/or components, but do not preclude the presence or addition of one or more other features, steps, operations, elements, components, and/or groups thereof. In addition, the steps and components described in the above embodiments and figures are merely illustrative and do not imply that any particular step or component is a requirement of a claimed embodiment.

1. A mass flow controller comprising:
an inlet for receiving fluid;
a flow path in which the fluid passes through the mass flow controller;
a mass flow sensor for providing a signal corresponding to mass flow of the fluid through the flow path;
an valve for regulating a flow of the fluid out of an outlet of the mass flow controller;
a storage medium comprising:
a fluid model of the fluid; and
a file system for configuring the fluid model; and
a processor operable to execute instructions to perform operations comprising:
receive instructions to configure the fluid model;
obtain mass flow controller data indicative of a change to the fluid model; and
utilize the file system to dynamically update the fluid model with mass flow controller data indicative of the change in the fluid model.

2. The mass flow controller of claim 1, wherein the processor is further operable to:
determine a location on a storage medium component of the mass flow controller to store the fluid model; and
dynamically store the fluid model on the determined the location.

3. The mass flow controller of claim 1, wherein the storage medium comprises a plurality of partitions, and wherein the processor is further operable to:
determine a partition designated to store the fluid model; and
dynamically adjust a partition size of at least one partition of the plurality of partitions if a size of the fluid model is greater than an amount of available storage space of the partition of the storage medium designated to store the fluid model.

4. The mass flow controller of claim 1, wherein the processor is further operable to:
receive mass flow controller data indicative of a new fluid model;
dynamically create the new fluid model; and
store the new fluid model on the storage medium.

5. The mass flow controller of claim 1, wherein the processor is further operable to:
access the fluid model stored on the storage medium; and
control the flow of the fluid through the outlet of the mass flow controller based on the fluid model stored on the storage medium.

6. The mass flow controller of claim 1, wherein the mass flow controller data comprises mass flow controller settings data, and wherein the processor is further operable to:
determine whether the mass flow controller data corresponds to mass flow controller settings data; and
update the fluid model with the mass flow controller settings data.

7. The mass flow controller of claim 1, wherein the mass flow controller data comprises mass flow controller measurement data, and wherein the processor is further operable to:
determine whether the mass flow controller data corresponds to mass flow controller measurement data; and
update the fluid model with the mass flow measurement data.

8. A computer-implemented method to dynamically configure data values stored on a mass flow controller, the computer-implemented method comprising:
receiving instructions to configure mass flow controller data;
determining a location on a storage medium component of the mass flow controller for storing the mass flow controller data, the storage medium having a first partition, wherein the location corresponds to a location of the first partition of the storage medium;
dynamically adjusting a partition size of the first partition if a size of the mass flow controller data is greater than an amount of available storage space of the partition of the storage medium; and
storing the mass flow controller data at the location on the storage medium.

9. The computer-implemented method of claim 8, wherein the mass flow controller data is stored on a data file having a file location, and
wherein determining the location of the storage medium for storing the mass flow controller data comprises:
determining the file location of the data file stored on the first partition; and
determining the location on the storage medium based on the file location of the data file.

10. The computer-implemented method of claim 9, further comprising:
determining if pre-existing mass flow controller data corresponding to the mass flow controller data are stored on the data file,
wherein storing the mass flow controller data comprises overwriting the pre-existing mass flow controller data with the mass flow controller data if pre-existing mass flow controller data corresponding to the mass flow controller data are stored on the data file.

11. The computer-implemented method of claim 9, wherein the storage medium comprises a plurality of partitions, and the computer-implemented method further comprising:
determining the amount of available storage space of the first partition;
determining an amount of available storage space of one or more other partitions of the plurality of partitions; and
reallocating the amount of available storage space of at least one of the one or more other partitions of the plurality of partitions,
wherein the partition size of the first partition is increased by the amount of available space reallocated from the at least one of the one or more other partitions of the plurality of partitions.

12. The computer-implemented method of claim 8, wherein the storage medium comprises a plurality of partitions, and the computer-implemented method further comprising:
determining, based on historical of instructions to configure the mass flow controller data, an anticipated size of the mass flow controller data to be configured within an operational duration; and
dynamically adjusting the partition size of the first partition if the anticipated size of the mass flow controller data to be configured within the operational duration is greater than the amount of available storage space of the first partition.

13. The computer-implemented method of claim 8, further comprising:
determining if the mass flow controller data is stored on the first partition;
dynamically creating a new data file to store the mass flow controller data if the mass flow controller data is not stored on the first partition; and
storing the new data file on the first partition.

14. The computer-implemented method of claim 8, wherein the mass flow controller data comprises mass flow controller settings data, wherein the first partition is designated to store the mass flow controller settings data, the computer-implemented method further comprising:
determining whether the mass flow controller data corresponds to mass flow controller settings data; and
storing the mass flow controller settings data on the first partition if the mass flow controller data corresponds to mass flow controller settings data.

15. The computer-implemented method of claim 14, wherein the mass flow controller settings data comprises mass flow controller configuration data, wherein the first partition comprises a mass flow controller configuration data file designated to store the mass flow controller configuration data, and the computer-implemented method further comprising:
determining if the mass flow controller data corresponds to the mass flow controller configuration data; and
storing the mass flow controller data on the mass flow controller configuration data file if the mass flow controller data corresponds to the mass flow controller configuration data.

16. The computer-implemented method of claim 14, wherein the mass flow controller settings data comprises mass flow controller firmware backup data, wherein the first partition comprises a mass flow controller firmware backup data file designated to store the mass flow controller firmware backup data, and the computer-implemented method further comprising:
determining if the mass flow controller data corresponds to the mass flow controller firmware backup data; and
storing the mass flow controller data on the mass flow controller firmware backup data file if the mass flow controller data corresponds to the mass flow controller firmware backup data.

17. The computer-implemented method of claim 14, wherein the mass flow controller settings data comprises mass flow controller diagnostic data, wherein the first partition comprises a mass flow controller diagnostic data file designated to store the mass flow controller diagnostic data, and the computer-implemented method further comprising:
determining if the mass flow controller data corresponds to the mass flow controller diagnostic data; and
storing the mass flow controller data on the mass flow controller diagnostic data file if the mass flow controller data corresponds to the mass flow controller diagnostic data.

18. The computer-implemented method of claim 8, wherein the mass flow controller data comprises mass flow controller measurement data, wherein the storage medium comprises a second partition designated to store the mass flow controller measurement data, and the computer-implemented method further comprising:
determining whether the mass flow controller data corresponds to mass flow controller measurement data; and
storing the mass flow controller measurement data on the second partition if the mass flow controller data corresponds to mass flow measurement data.

19. The computer-implemented method of claim 18, wherein the mass flow controller measurement data comprises data indicative of a flow rate of a substance measured by the mass flow controller, wherein the second partition comprises a substance flow rate data file designated to store data indicative of a flow rate of the substance, and the computer-implemented method further comprising:
determining if the mass flow controller data corresponds to data indicative of a flow rate of the substance; and
storing the mass flow controller data on the substance flow rate data file if the mass flow controller data corresponds to data indicative of a flow rate of the substance.

20. The computer-implemented method of claim 18, wherein the mass flow controller measurement data comprises data indicative of properties of a substance measured by the mass flow controller, wherein the second partition comprises a substance properties data file designated to store data indicative of the properties of the substance, and the computer-implemented method further comprising:
determining if the mass flow controller data corresponds to data indicative of the properties of the substance; and
storing the mass flow controller data on the substance properties data file if the mass flow controller data corresponds to data indicative of the properties of the substance.

21. The computer-implemented method of claim 18, wherein the mass flow controller measurement data comprises data indicative of historical measurements of a substance measured by the mass flow controller, wherein the second partition comprises a historical measurements data file designated to store data indicative of the historical measurements of the substance, and the computer-implemented method further comprising:
determining if the mass flow controller data corresponds to data indicative of the historical measurements of the substance; and
storing the mass flow controller data on the historical measurements data file if the mass flow controller data corresponds to data indicative of the historical measurements of the substance.

22. A non-transitory computer-readable medium comprising instructions stored therein, which when executed by one or more processors, causes the one or more processors to perform operations comprising:
receiving instructions to store mass flow controller data on a storage medium of a mass flow controller;
utilizing a file system to determine if a data file designated to hold the mass flow controller data is stored on the storage medium;
updating the data file to include the mass flow controller data if the data file is stored on the storage medium; and
creating a new data file having the mass flow controller data if the data file is not stored on the storage medium.
